(19) United States
(12) Patent Application Publication
(10) Pub. No.: US 2010/0043149 A1
(43) Pub. Date: Feb. 25, 2010

(54) HAMMER WITH A PRY BAR

(76) Inventor: Yung-Shou Chen, Taichung Hsien (TW)

Correspondence Address: PAI PATENT & TRADEMARK LAW FIRM, 1001 FOURTH AVENUE, SUITE 3200, SEATTLE, WA, 98154, US

(21) Appl. No.: 12/194,425

(22) Filed: Aug. 19, 2008

(51) Int. Cl. B25D 1/00; B66F 15/00

(52) U.S. Cl. 7/143; 81/20; 7/166

(57) ABSTRACT

A hammer having a pry bar extending from the bottom stem of the metal hammerhead thereof in parallel to the extending direction of the bell unit, a clamping mouth defined between the bell unit and the pry bar for clamping to a wooden board for mounting or dismounting, and two series of teeth respectively formed on the top side of the pry bar and the bottom side of the neck of the bell unit for engaging the wooden board inserted into the clamping mouth. The teeth at the bell unit have the tooth peaks disposed in flush with the periphery of the bell of the bell unit.

### BACKGROUND OF THE INVENTION

(a) Field of the Invention

The present invention relates to a hammers and, more particularly, to a hammer that has a pry bar extending from the bottom stem of the metal hammerhead and defining with the bell unit a clamping mouth for securing to a wooden board to facilitate mounting or dismounting of the wooden board.

(b) Description of the Prior Art

A claw hammer generally comprises a metal hammerhead and a handle. The metal hammerhead has a claw at the front side for pulling nails and a bell unit at the rear side for hammering. Therefore, a conventional claw hammer simply provides hammering and nail-pulling functions. Further, the center of gravity of a conventional hammer is biased to the front side of the metal hammerhead. When operating a conventional hammer to drive a nail into a workpiece, the heavy front side of the hammer causes the user difficult to control the point of application of force, and the hammering force may be inaccurately applied to the center of the head of the nail, causing the nail to be curved. Further, during hammering, the user needs to apply much effort to hammer the nail with the hammer.

### SUMMARY OF THE INVENTION

The present invention has been accomplished under the circumstances in view. According to one aspect of the present invention, the hammer comprises a pry bar extending from the bottom stem of the metal hammerhead thereof in parallel to the extending direction of the bell unit and defining with the bell unit a clamping mouth for clamping to a wooden board so that the pry bar works as a counterweight to keep the hammer in balance and to avoid shift of the center of gravity to the front side of the hammer for enabling the user to control the point of application of force accurately and to the nail into the workpiece with the hammer with less effort.

According to another aspect of the present invention, two series of teeth are respectively formed on the top side of the pry bar and the bottom side of the neck of the bell unit for engaging the wooden board inserted into the clamping mouth so that the hammer can clamp the wooden board firmly.

### BRIEF DESCRIPTION OF THE DRAWINGS

FIG. 1 is a perspective view of a hammer in accordance with the present invention.

FIG. 2 is a side view of the hammer in accordance with the present invention.

FIG. 3 is a schematic drawing showing an application example of the present invention (I).

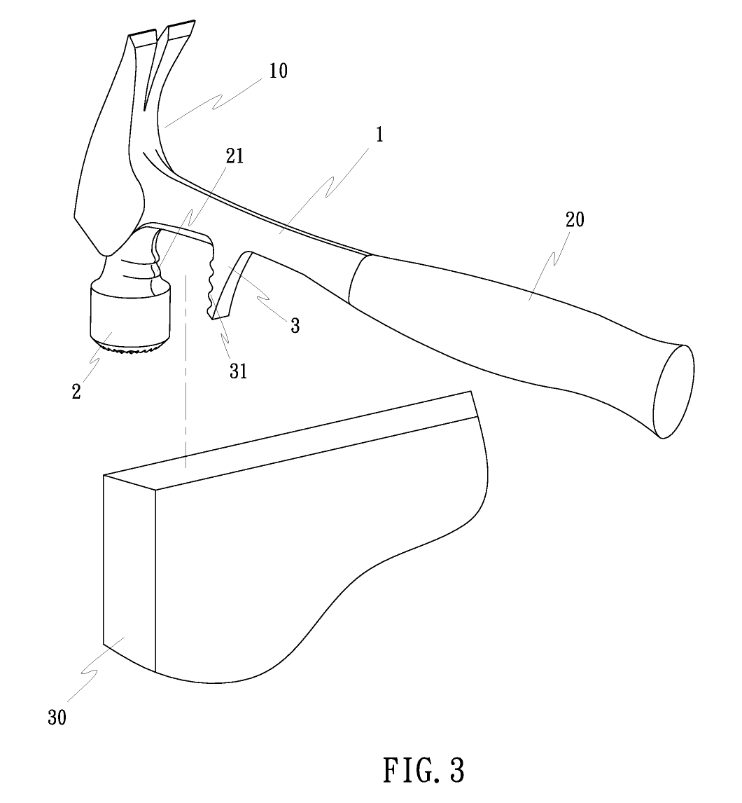

FIG. 4 is a schematic drawing showing an application example of the present invention (II).

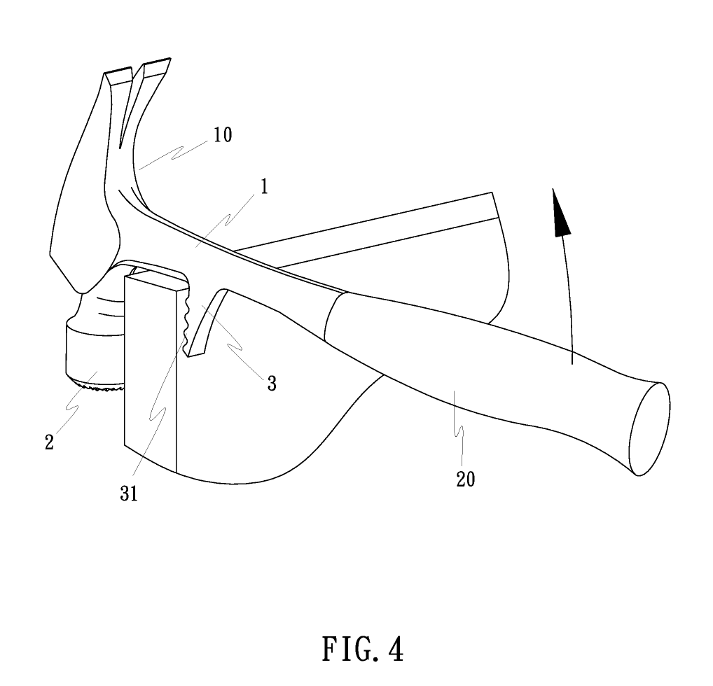

### DETAILED DESCRIPTION OF THE PREFERRED EMBODIMENTS

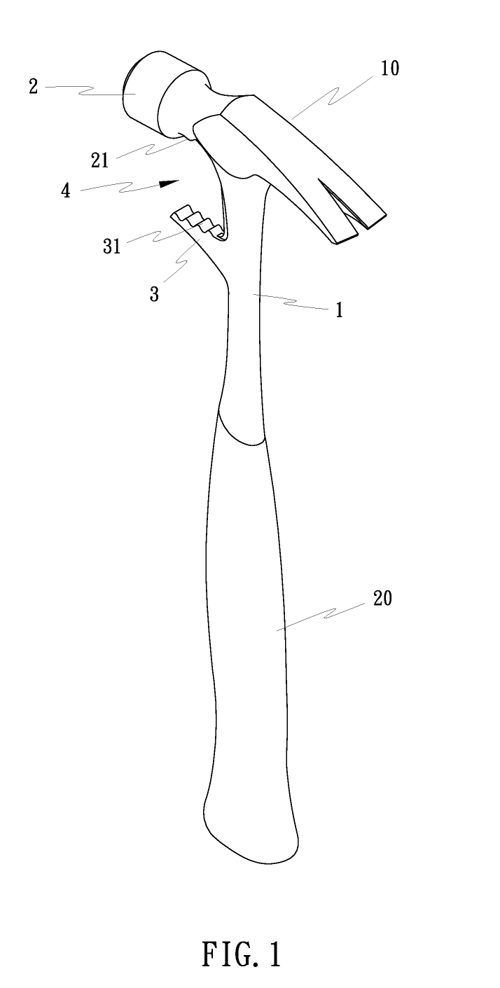

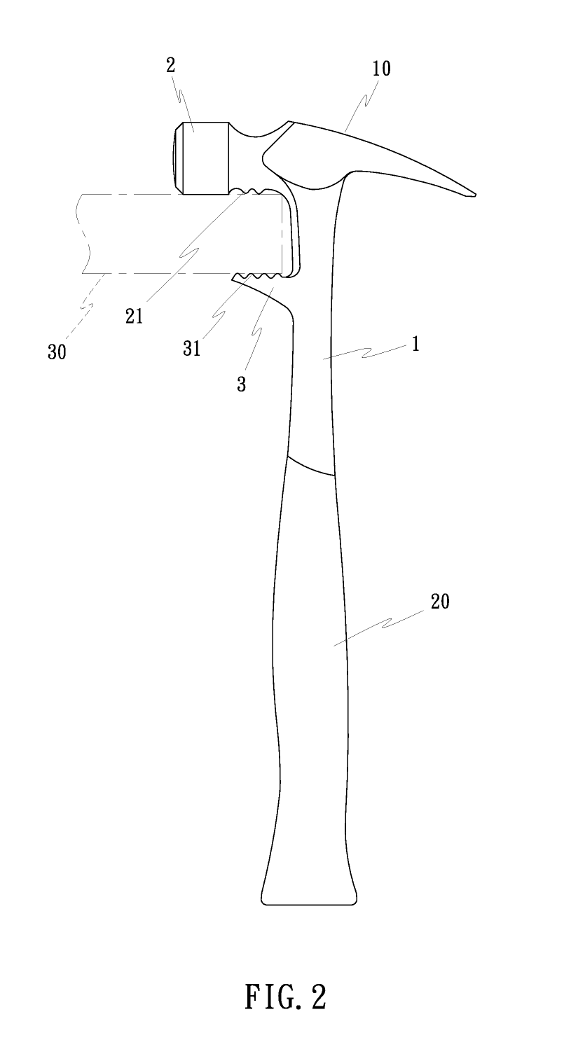

As shown in FIGS. 1 and 2, a hammer with lateral nail-pulling function in accordance with the present invention comprises a handle 20 and a metal hammerhead 10 at one end of the handle 20. Similar to conventional hammers, the hammerhead 10 comprises a bell unit 2 at one side for hammering and a claw at the opposing side for removing nails. Further, the hammerhead 10 comprises a stem 1 perpendicularly extending from the middle part of the bottom side thereof and affixed to one end of the handle 20, and a pry arm 3 extending from the stem 1 in a substantially parallel direction relative to the extending direction of the bell unit 2 The pry arm 3 and the bell unit 2 define a claiming mouth 4 for clamping to a wooden board 30 (see FIGS. 2˜4) in order to mount the wooden board 30. Therefore, the hammer provides hammering and nail-removing functions and can be used to carry out a prying function for dismounting a wooden board 30.

As stated above, the pry arm 3 extends in a parallel direction relative to the bell unit 2 and is spaced below the bell unit 2 at a predetermined distance, and therefore a proper claiming mouth 4 is defined between the pry arm 3 and the bell unit 2. Further, the length of the pry arm 3 is shorter than the bell unit 2. Further, the design of the pry arm 3 gives a counterweight to the bell unit 2, keeping the hammer in balance and preventing shift of the center of gravity to the front side. When hammering a nail into a workpiece, the user can accurately control the point of application of force, thereby driving the nail into the workpiece accurately with less effort.

Further, two series of teeth 21 and 3 1 are respectively formed on the bottom side of the neck of the bell unit 2 and the top side of the pry arm 3, enhancing the clamping strength of the clamping mouth 4. When the clamping mouth 4 is attached to a wooden board 30, the series of teeth 21 and 31 enhance the engagement between the clamping mouth 4 and the wooden board 30. Further, the peaks of the teeth 21 and 31 are disposed in flush with the periphery of the bell of the bell unit 2 so that the teeth 21 and 31 effectively engage the wooden board 30 when the wooden board 30 is inserted into the clamping mouth 4 (see FIG. 2).

Although a particular embodiment of the invention has been described in detail for purposes of illustration, various modifications and enhancements may be made without departing from the spirit and scope of the invention. Accordingly, the invention is not to be limited except as by the appended claims.

1. A hammer comprising a handle and a metal hammerhead at one end of said handle, said metal hammerhead comprising
a bell unit having a neck and a bell connected to a first end of the neck,
a stem perpendicularly extending from a second end of the neck and affixed to said handle,
a pry bar extending from the periphery of said stem and spaced directly below said bell unit to counterbalance said bell unit, and
a clamping mouth defined between said bell unit and said pry bar for clamping to a wooden board.

2. The hammer as claimed in claim 1, wherein said bell unit and said pry bar extend in parallel.

3. The hammer as claimed in claim 1, wherein said pry bar is shorter than said bell unit.

4. The hammer as claimed in claim 1, wherein said pry bar comprises a series of teeth formed on a top side thereof within said clamping mouth; said bell unit comprises a series of teeth formed on a bottom side of said neck within said clamping mouth and corresponding to the teeth on said pry bar.

5. The hammer as claimed in claim 4, wherein the teeth of said bell unit have respective tooth peaks in flush with the lower side of said bell.
